(19) United States
(12) Patent Application Publication
(10) Pub. No.: US 2008/0099094 A1
(43) Pub. Date: May 1, 2008

(54) Water Saving Device

(75) Inventor: Meng Loong, Singapore (SG)

Correspondence Address: VOLPE AND KOENIG, P.C., UNITED PLAZA, SUITE 1600, 30 SOUTH 17TH STREET, PHILADELPHIA, PA, 19103, US

(73) Assignee: JVL ENGINEERING PTE LTD, Singapore (SG)

(21) Appl. No.: 10/570,064

(22) PCT Filed: Feb. 7, 2005
(86) PCT No.: PCT/SG05/00028

§ 371 Date: Mar. 1, 2006

(30) Foreign Application Priority Data
Feb. 6, 2004 (SG) 200400564-1
Oct. 27, 2004 (AU) 2004906200

(51) Int. Cl. F16L 55/00; E03C 1/08

(52) U.S. Cl. 138/43; 138/46; 239/428.5

(57) ABSTRACT

A water saving device for use at or near a water outlet has a first water flow regulating element; a second water flow regulating element disposed downstream of the first regulating element; and a chamber formed between the first and second regulating elements. All of one or more water flow regulating parts of the second regulating element are made from substantially solid material.

### FIELD OF INVENTION

The present invention relates broadly to a water saving device for use at or near a water outlet.

### BACKGROUND

In former times, fresh water was freely available and was thought by some to be an inexhaustible resource. Many communities provided unlimited supplies of water to commercial and residential consumers at a very low cost. Thus, with water conservation having a low priority, little thought was given to it in the design of water-using appliances.

Currently, a combination of factors such as rising urban populations, diminishing water tables and near drought condition in various parts of the world, have combined to diminish the amount of fresh water available to the public. In response to these factors, the public has become aware of the necessity and in some cases, the urgency of water conservation measures. In this regard, water rates are being implemented in many communities throughout the world.

As a result of such water conservation efforts now taking place, both voluntarily and as a result of legislation, homemakers and business managers alike are actively seeking ways to conserve this precious resource. Manufacturers of water consuming appliances, such as taps, shower handles and dishwashers, are developing new products, which perform efficiently, while consuming less water than earlier models. As a result, new appliances are gradually replacing the older appliances, which may be phased out of service over about a ten year period, for example, this will result in significant water conservation.

Several problems may be encountered when using the conventional water saving devices. One of the problems is that the water pressure out from the water saving devices is typically reduced as a result of reduced water flow. It would be desirable to minimise the reduction of water pressure for a given reduced water flow in order to maintain a perception of sufficient water flow for the consumer.

### SUMMARY

In accordance with an aspect of the present invention, there is provided a water saving device for use at or near a water outlet, the device comprising: a first water flow regulating element; a second water flow regulating element disposed downstream of the first regulating element; a chamber formed between the first and second regulating elements; wherein all of one or more water flow regulating parts of the second regulating element are made from substantially solid material.

The chamber may separate the first and second regulating elements by a distance chosen such that a water force prior to the second regulating element has a desired value.

The distance may be about ⅓ of a diameter of a water supply line for the outlet.

The second regulating element may be mounted within the chamber in a substantially airtight manner under water flow.

The device may further comprise one or more netting elements disposed downstream of the second regulating element.

The first regulating element may comprise an array of holes. The number or holes may range from 1 to 4.

The holes may be substantially circular in shape. The diameter of the holes may be from about 1.5 mm to 3 mm.

The distance between the first and second water flow regulating elements may be adjustable.

### BRIEF DESCRIPTION OF DRAWINGS

Embodiments of the invention will be better understood and readily apparent to one of ordinary skill in the art from the following written description, by way of example only, and in conjunction with the drawings, in which:

FIG. 1a shows a schematic cross-sectional view of a water saving device in an example embodiment.

FIGS. 1b, 1c and 1d are schematic plan views of components of the water saving device of FIG. 1a.

FIG. 2a and 2b are schematic drawings illustrating application of water saving devices according to example embodiments of the present invention being used in a water tap and in a shower head respectively.

FIG. 3 shows a table illustrating a comparison in water flow and water pressure between an existing water saving device and a water saving device according to the example embodiments.

### DETAILED DESCRIPTION

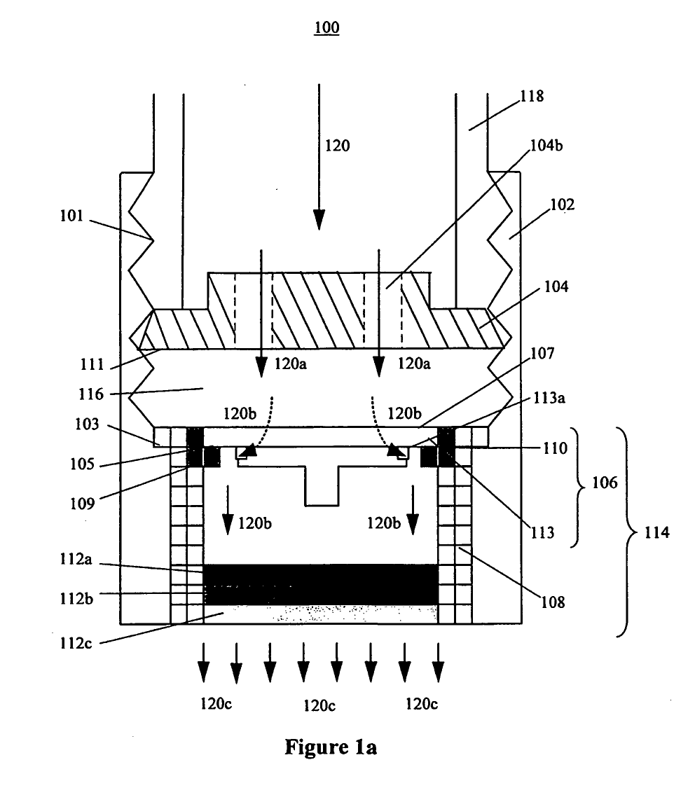

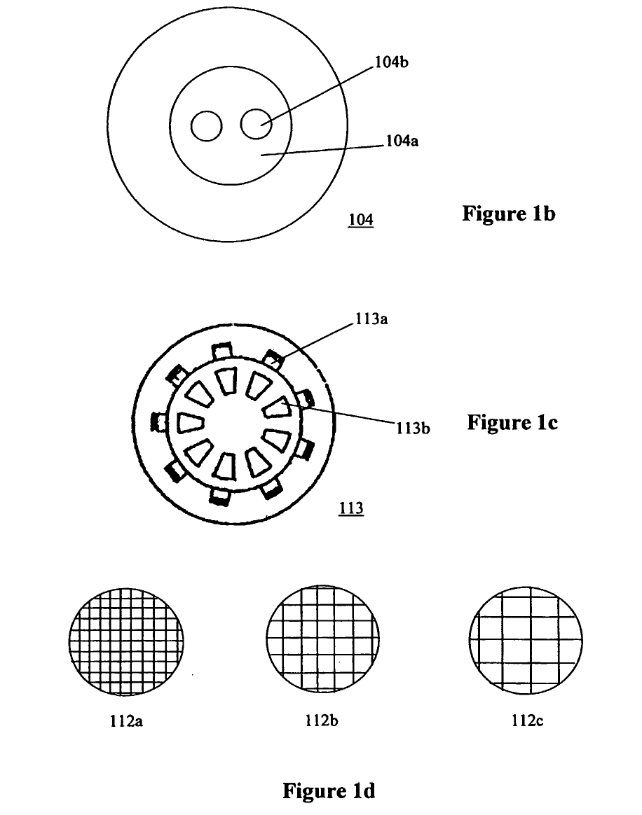

FIG. 1a shows the schematic diagram of the water saving device 100 in an example embodiment. The water saving device 100 comprises an enclosure 102, an upper flow regulating structure 104, a lower flow regulating structure 106 and a mesh socket 108. In the example embodiment, the enclosure 102 is made of material such as chromed metal. The enclosure 102 has threads 101 around its inner circumference. The threads 101 start from a top end of the enclosure 102 and extend to about half of the height of the enclosure 102. There is a rim 103 in the enclosure 102 near where the threads 101 end. The lower flow regulating structure 106 consists of a disk 113 and a ring housing 110.

FIG. 1b shows a plan view of the upper flow regulating structure 104 in an example embodiment. The upper flow regulating structure 104 has a circular protrusion 104a in the centre. There are two holes 104b aligned on a centre line on the surface of the protrusion 104a in the example embodiment. The two holes 104b extend from the surface of the protrusion 104a to the other side of the upper flow regulating structure 104. There are threads (not shown) around the outer circumference of the upper flow regulating structure 104.

FIG. 1c shows a top view of the disk 113 of the lower flow regulating structure 106 (FIG. 1a) in an example embodiment. The disk 113 is made of thermosetting plastics. There are numerous small channels 113a around the circumference of the disk 113. A series of small protrusions 113b is arranged in a circular manner in front of the various channels 113a.

Referring back to FIG. 1a, the disk 113 is disposed in the ring housing 110. There is a rim 105 on the inner side of the ring housing 110 for receiving the top part 107 of the disk 113. The lower flow regulating structure 106 is then received in the mesh socket 108 in the example embodiment. Similarly, there is a rim 109 near one of the ends of the mesh socket 108 to receive the lower flow regulating structure 106. The disk 113, the ring housing 110 and the mesh socket 108 are designed to snap fit together in the example embodiment.

At the other end of the mesh socket 108, three meshes 112a, 112b and 112c are mounted, with the most dense mesh 112a as the topmost layer and the least dense mesh 112c as the bottom layer. FIG. 1d shows the three meshes 112a, 112b and 112c with different density in an example embodiment. The meshes 112a, 112b and 112c are made up of thin anti rust wire intercrossed to form a web-like structure. The meshes 11 2a, 11 2b and 11 2c facilitate a more even distribution of the water flow at a water outlet.

In the example embodiment, the structure 114 comprising of the lower flow regulating structure 106 and the mesh socket 108 is disposed in the enclosure 102 as shown in FIG. 1a. The top part of the structure 114 sits on the rim 103 of the enclosure 102 so that it will not fall through the enclosure 102.

After the structure 114 is disposed in the enclosure 102, the upper flow regulating structure 104 is screwed into the enclosure 102, with its flat surface 11 facing the lower flow regulating structure 106. A substantially airtight chamber 116 is created between the upper flow regulating structure 104 and lower flow regulating structure 106 in the example embodiment. It is noted that no deformable components such as neoprene O-ring are used in the engagement between the lower flow regulating structure 106, the mesh socket 108 and the enclosure 102. The disk 113 and the ring housing 110 are made from substantially solid materials. Due to the non-expandable nature of the solid materials under water pressure, leakage from the chamber 116 will be minimised, thus maintaining the water pressure in the chamber 116.

In the example embodiment, the water saving device 100 is designed such that the height of the chamber 116, which is the distance between the bottom layer of the upper flow regulating structure 104 and the top layer of the lower flow regulating structure 106, is about one-third of the diameter of a tap outlet 118. A distance may be varied to regulate a water force (and thus pressure) upon exit from the water saving device 100. It was found that a larger distance increases the water force and thus pressure.

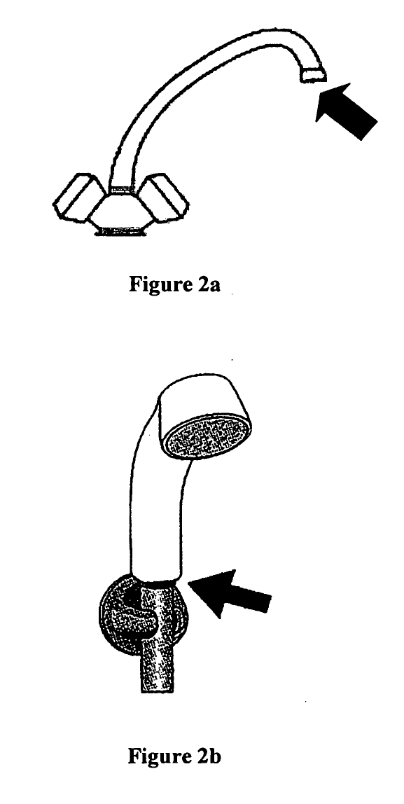

The water saving device 100 is screwed to the tap outlet 118 using the remaining threads of the enclosure 102 in an example embodiment. The water saving device 100 can be used on any water tap outlet such as e.g. illustrated in FIG. 2a or shower heads such as e.g. illustrated in FIG. 2b in example embodiments.

Water saving is carried out by positioning the water saving device 100 along the tap water line 120 at or near the water outlet. The water saving device 100 divides the tap water line 120 along the direction of flow through the means of holes e.g. 104b and channels e.g. 113a and thereby limits the flow of water. The volume of the water that flows out at tap water line 120c is thus significantly reduced.

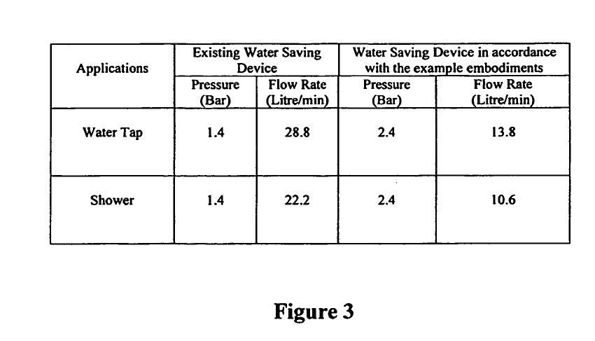

However, as mentioned above, in comparison to the existing water saving devices, the water saving device in accordance with the example embodiment of the present invention can maintain increased pressure at the water outlet. FIG. 3 shows a comparison of measured pressures and flow rates at the water outlet between an existing water saving device and a water saving device in accordance with the example embodiment of the present invention.

As seen in FIG. 3, with the existing water saving device, when the flow rate is reduced to 28.8 litre/min, already the pressure at the outlet is reduced to 1.4 bar for a water tap from a typical line pressure in a household of 2.5 to 3 bar. However, with the water saving device in accordance with the example embodiment of the present invention, even at a flow rate of 13.8 litre/min, the outlet pressure is maintained at 2.4 bar. Similar experiments were conducted at a shower head with the existing water saving device and the water saving device in accordance with the embodiment of the present invention. FIG. 3 thus illustrates the advantages that can be achieved as a result of the minimisation of leakage in water saving devices according to embodiments of the present invention.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

The configuration of the example embodiments in FIGS. 1a-1d is not limited as aforementioned. The materials used for manufacturing the various components of the water saving device 100 are not restricted to those mentioned. The enclosure 102 may be formed by separate parts, e.g. top, middle and bottom enclosures instead of being an one-piece structure. The enclosure 102 and the upper flow regulating structure 104 may be secured together by bolts or welding. The number of holes 104b and channels 113a is not limited to that shown in FIGS. 1b and 1c. The holes 104b may adopt other shapes. The size of the water saving holes 104b and 113a is also not limited as shown in this configuration. The number and the density of the meshes 112 may vary in each water saving device 100.

1. A water saving device for use at or near a water outlet, the device comprising:
a first water flow regulating element;
a second water flow regulating element disposed downstream of the first regulating element;
a chamber formed between the first and second regulating elements;
wherein all of one or more water flow regulating parts of the second regulating element are made from substantially solid material.

2. The device as claimed in claim 1, wherein the chamber separates the first and second regulating elements by a distance chosen such that a water force prior to the second regulating element has a desired value.

3. The device as claimed in claim 1, wherein the distance is about ⅓ of a diameter of a water supply line for the outlet.

4. The device as claimed in claim 1, wherein the second regulating element is mounted within the chamber in a substantially airtight manner under water flow.

5. The device as claimed in claim 1, further comprising one or more netting elements disposed downstream of the second regulating element.

6. The device as claimed in claim 1, wherein the first regulating element comprises an array of holes.

7. The device as claimed in claim 1, wherein said holes are substantially circular in shape.

8. The device as claimed in claim 1, wherein the distance between the first and second water flow regulating elements is adjustable.
